(19) United States
(12) Patent Application Publication
(10) Pub. No.: US 2026/0022652 A1
(43) Pub. Date: Jan. 22, 2026

(54) OPERATING ASSEMBLY FOR PUMPS FOR RECIRCULATING A COOLING FLUID OF COMBUSTION ENGINES AND RECIRCULATING PUMP PROVIDED WITH SUCH AN OPERATING ASSEMBLY

(71) Applicant: BARUFFALDI S.p.A., Tribiano (MI) (IT)

(72) Inventors: Niccolò NUCCI, Tribiano (IT); Simone RONA, Tribiano (IT); Leonardo MOLINARI, Tribiano (IT)

(21) Appl. No.: 18/994,972

(22) PCT Filed: Aug. 2, 2023
(86) PCT No.: PCT/IB2023/057824

§ 371 Date: Jan. 15, 2025

(30) Foreign Application Priority Data
Aug. 5, 2022 (IT) 102022000016869

(51) Int. Cl. F01P 5/12; F04D 13/02; F04D 13/06

(52) U.S. Cl. CPC F01P 5/12; F04D 13/024; F04D 13/06

(57) ABSTRACT

Operating assembly for a pump for recirculating a cooling fluid for a vehicle, comprising: an axially extending driven shaft (2) with a front end (2a) designed to carry the impeller (1) of a pump, at least one electromagnetic friction clutch (2), arranged between a movement take-up element (223,202) for taking up the rotational movement and the driven shaft (2), an electric drive for driving the driven shaft (2), independent of the movement take-up element, a support body (11;113) extending axially between a front part which carries the front end of the shaft (2) and a rear foot which supports the movement take-up element.

### DESCRIPTION

The present invention relates to an operating assembly for pumps for recirculating the cooling fluid of combustion engines, in particular of vehicles, with an operating device comprising an electromagnetic clutch and an electric drive which is independent of the combustion engine, as well as to a recirculating pump provided with said operating assembly.

It is known in the sector for the production of engines, in particular combustion engines, that there exists the need to cool said engines by means of recirculation of a cooling fluid which is driven by means of a corresponding recirculating pump, the impeller of which is rotationally driven by a shaft operated by a pulley and a belt connected to the driving shaft.

It is also known that recirculation of the cooling fluid must be performed with a flowrate corresponding to the actual cooling requirement determined by the real conditions of use of the engine and by the external temperature, in order to avoid the constant and unnecessary operation at full speed of devices which draw useful power and thereby increase the wear of the various component parts and the consumption levels of the vehicle.

It is also known that, in order to solve this problem, hybrid devices have been proposed for controlling operation of the pump impeller shaft, rotation of which depends on the engagement of a friction coupling for transmission of a rotational movement depending on the revolutions of the driving shaft, and on an electric motor, which instead is activated when the friction coupling is disengaged, for rotation of the impeller at a controlled speed independent of the driving shaft.

Although performing their function, these devices nevertheless have drawbacks which limit their applications, in particular since the known configurations have axial dimensions which are incompatible with the free volumes available inside the engine compartment, in particular as regards the limited amount of axial space available between the pump and the fan which forces air onto the cooling liquid contained inside the front radiator, these requiring respective drive belts for connection to the combustion engine in order to take up the rotational movement.

The technical problem which is posed therefore is that of providing an operating assembly for pumps for recirculating cooling fluids for engines of vehicles and the like, able to produce a variation in the speed of rotation of the pump impeller depending on the actual operating requirement of the engine.

In connection with this problem it is also required that the operating assembly should have a configuration designed to ensure overall dimensions of the pump equipped with this assembly such that there is a distance, in the axial direction, from the vehicle fan able to avoid damaging interference between them.

A further object is that the pump operating assembly should be able at the same time to output high torques also at a low speed of rotation of the engine, so as to be applicable also to high-capacity pumps of heavy vehicles having an engine with a low number of revolutions, or rotation of the impeller at a low number of revolutions when the combustion engine is running at a high speed.

It is also required the device should be easy and inexpensive to produce and assemble and be able to be easily installed on the pump body without the need for special adaptation.

These results are obtained according to the present invention by an operating assembly for pumps for recirculating cooling fluids of engines for vehicles and the like according to the characteristic features of claim 1.

The present invention relates furthermore to a pump for recirculating cooling fluids of engines for vehicles and the like equipped with such an operating assembly.

Further details may be obtained from the following description of a non-limiting example of embodiment of the subject of the present invention provided with reference to the attached drawings in which:

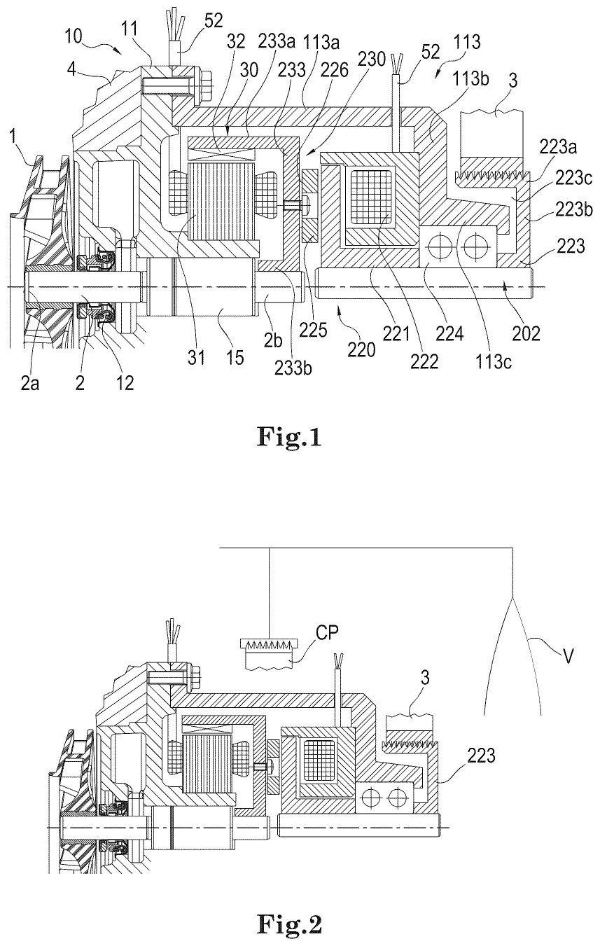

FIG. 1: is a cross-sectional view of a first example of embodiment of an operating assembly for a pump according to the present invention;

FIG. 2: is an overall cross-sectional view of the pump operating assembly installed with an adjacent cooling fan.

As shown in FIG. 1, the operating assembly comprises a shaft 2, on the front end 2a of which the impeller 1 of a pump for recirculating the cooling fluid of vehicles is mounted. The shaft 2 is supported by a fixed support body 10 in turn fixed to the base 4 of the vehicle engine.

The support body of the pump operating assembly comprises a first body part 11, close to the impeller, supporting said front end 2a of the shaft 2.

The first body part 11 is secured to the base 4 and has, arranged inside it, a sealing gasket, coaxial with the shaft 2, and a bearing 15 onto the inner ring of which the shaft 2 of the impeller is keyed.

The first pump body part 11 has, secured thereto, a front end of a second fixed body part, formed by a bell member 13, which in the cross-sectional illustration is shown as being Z-shaped and comprises: a front and radially outer axial arm 113a, a radial arm 113b extending from the axial arm towards the axis of rotation of the shaft 2 and an axial foot 13c extending from the radial arm and axially distant from the impeller 1.

In the preferred embodiment shown, the clutch 220 comprises:
a fixed electromagnet 222 integral with the bell member 113 on its radial arm 113b;
a mechanical rotor 221, preferably with an L-shaped cross-sectional form;
an armature 225 arranged facing the electromagnet 222, with a front surface of the rotor 221 arranged between the electromagnet 222 and the armature 225 itself.

The mechanical rotor 221 is integral with an auxiliary spindle 202 keyed onto the inner race of a bearing 224, the outer race of which has, keyed thereon, the foot 113c of the bell member 113, which therefore supports the spindle 202 with the possibility of relative rotation.

The shaft 2 of the impeller and the auxiliary spindle 202 are preferably coaxial and independent.

A pulley 223a is rigidly connected to the rear end of the spindle 202 carried by the foot 113c. The pulley 223a is suitable for coupling with a belt 3 connected to a driving shaft or driven shaft of the combustion engine, therefore forming an element for taking up the rotational movement, for example transmitted from the shaft of the combustion engine, for rotational operation of the spindle 202 and therefore the mechanical rotor 221.

According to the preferred embodiment of FIG. 1, the pulley 223a is formed on the outer side surface of a movement take-up flange 223 fixed to the rear end of the spindle 202. The flange 223 has a radially outer axial arm on which the pulley 223a is formed. A front end of the axial arm is free, while the rear end is connected to a radial arm 223b connected to the spindle 202 by means of a radially inner foot.

The flange 223 defines an internal volume 223c between the outer axial arm and the inner foot, inside which preferably the rear foot 113c of the pump body 10 is at least partially housed, reducing the axial dimension of the pump unit.

On its face opposite to the electromagnet 222, the armature 225 supports an elastic plate 226 secured to a flange 233 in turn integral with the end 2b of the shaft 2, opposite to that of the impeller 1; the armature 225 is therefore rotationally integral with the said flange 233.

By means of this coupling the armature 225 is able to perform movements in the axial direction towards/away from the mechanical rotor 221 so that, when the electromagnet 22 is energized, the armature 225 and the flange 226a are rotationally coupled to the rotor 221, but are instead stationary in the idle condition when the electromagnet 222 is de-energized.

As shown in FIG. 1, it is also envisaged that an electric drive, in particular an electric motor 30, is arranged inside the bell member 113, in an axial position between the impeller 1 of the pump and the electromagnetic clutch 220.

In greater detail, the electric motor 30 comprises a stator 31 mounted fixed on the support body 11, and an electric rotor 32 mounted on a first axial extension 233a of the flange 233, designed to arrange the rotor in a radially outer position concentric with respect to the stator, for radial coupling therewith.

A second axial extension 233b of the rotor flange 233, opposite to the preceding flange, is integral with the shaft 2 of the impeller 1.

The operating assembly according to the present invention therefore preferably has an arrangement which comprises, in sequence along the axial development of the assembly: impeller 1, electric motor 30, flange 233 of the electric rotor, armature 225, mechanical rotor 221, electromagnet 222 and movement take-up element 223. The electric rotor 33 and the armature 225 are rotationally coupled to the shaft 2 of the impeller, while the mechanical rotor 221 and the movement take-up element 223 are rotationally coupled to the auxiliary spindle 202.

Owing to the constructional form of the supporting body, preferably made as two parts 11, 113, with bell member 113, which houses the electric motor 30 and supports at a rear end the bearing 224, the auxiliary spindle 202, the movement take-up flange 223 and the mechanical rotor 222, it is possible to freely determine the diameter of the movement take-up pulley 223a, which is thus free from dimensional constraints (for example due to the magnetic circuit of the clutch rotor). It is therefore possible to easily configure a desired speed multiplication/reduction ratio with respect to the pulley and belt of the combustion engine.

Furthermore, owing to the arrangement of the present invention, it is also possible to simplify significantly the production and assembly process, with savings in terms of costs and material.

FIG. 2 shows how with the innovative structure of the pump operating assembly it is possible to arrange the movement take-up element 223a, suitable for coupling with the secondary belt 3 driving the pump impeller, in an axially outer position, at the rear end, opposite to the impeller, of the operating assembly, thus resulting in an axial length of the entire assembly such that sufficient space without interference is left between the assembly itself and the fan V for cooling the fluid inside the front radiator. This avoids, moreover, interference with the primary belt CP for driving the fan, which is situated in an axial position between the impeller 1 and the belt 3 of the pump.

In addition to this, it is pointed out that the pulling force of the belt 3 is discharged onto the rear bearing 224 carried by the extension 113c of the bell 113 fixed to body 11, as a result of which it is possible to limit the dimensions of the inner bearing 15 which is housed in the first part of body 11 and is not subjected to the dynamic radial loads of the belt 3, but must withstand only the mass of the impeller and electric rotor 32, armature 225 and associated flange 233, thus increasing the working life of the transmission and limiting the overall dimensions.

Moreover, owing to the operating structure of the present invention, it is also advantageously possible to keep the radial dimensions of the pump unit compact.

With these configurations the operating principle of the pump is as follows:
when the electromagnet 222 is energized, the magnetic field induced overcomes the elastic resistance of the plate 226, recalling axially the armature 225 with consequent engagement thereof with the mechanical rotor 221 moved by the pulley 223a via the auxiliary spindle 202; the engagement causes the rotation of the flange 223 with consequent operation of the shaft 2 of the impeller 1 at the speed determined by the combustion engine via the belt 3 and the pulley 223a;
when the electromagnet 222 is de-energized, the armature 225 is recalled by the elastic plate 226 axially away from the electromagnet 222, thereby detaching the mechanical rotor 221 from the flange 223 and therefore from the shaft 2 of the impeller which remains idle;
if, in the idle condition of the shaft 2, a rotation of the impeller 1 at a speed independent of that determined by the combustion engine is required, the electric motor 30 is powered so that the movement of its rotor 32 causes the rotation of the shaft 2 at the desired speed of rotation suitable for determining recirculation of the fluid which is actually required.

It is clear how the operating assembly for recirculation pumps according to the invention is able to ensure efficient driving of the pump impeller with recirculation of the vehicle cooling fluid which may be varied depending on the actual need by means of alternative driving by the combustion engine or by the auxiliary electric motor, while maintaining however, small radial dimensions which allow a pulley also with a compact diameter to be obtained, with consequent multiplication of the revolutions transmitted by the belt 3, thus making the device, and therefore the pump, also suitable for vehicles with engines which run at a low number of revolutions, but which require a high speed of rotation of the cooling pump.

In addition, the size of the pulley is not dependent on the size of the external diameter of the electric motor.

Although described in connection with an application relating to a water recirculating pump, it is understood that the cooling fluid could also be oil and that the operating assembly according to the present invention may therefore be used for an oil pump.

1. An operating assembly for operating a pump for recirculating a cooling fluid of a vehicle, comprising:
a driven shaft (2) extending axially with a front end (2a) designed to carry the impeller (1) of a pump;
an electromagnetic friction clutch (220) arranged between a movement take-up element (223,223a) for taking up a rotational movement and the driven shaft (2);
an electric drive (30) for driving the driven shaft (2), independent of the movement take-up element;
a support body (11;113) extending axially between a front part which carries the front end of the shaft (2) and a rear end which rotationally supports said movement take-up element;
wherein the electric drive (30) and the electromagnetic clutch (220) are axially arranged between the front end (2a) of the shaft and said movement take-up element (223,223a).

2. The operating assembly according to claim 1, wherein the support body is made in two parts and comprises a first front body part (11) which supports said front end (2a) of the shaft (2) and is designed to be secured to a fixed base (4), and a bell member (113) secured to the first body part (11) and comprising a radially inner and axially extending rear foot (113c) which forms said rear end designed to support the movement take-up element (223,223a) for taking up the movement.

3. The operating assembly according to claim 2, wherein a first bearing (15) is arranged between the shaft (2) and the first body part (11) of the support body.

4. The operating assembly according to claim 2, wherein said bell member (113) comprises: a front and radially outer axial arm (113a) secured to the first body part (11) of the support body; a radial arm (113b) extending from the axial arm towards the axis of rotation of the shaft (2) and said foot (113c) extending from the radial arm and axially distal from the impeller (1).

5. The operating assembly according to claim 2, wherein the electromagnetic clutch (20) comprises:
a fixed electromagnet (22) integrally joined to the support body, in particular to the bell member (113);
a mechanical rotor (221), preferably with an L-shaped cross-section;
an armature (225) arranged facing the electromagnet (222), with a radial front surface of the rotor (221) arranged between the electromagnet (222) and the armature (25).

6. The operating assembly according to claim 1, further comprising an auxiliary spindle (202) keyed onto an inner race of a rear bearing (224) mounted on the rear end of the support body, in particular on the rear foot (113c), wherein the movement take-up element (223, 223a) is rotationally integral with the spindle (202).

7. The operating assembly according to claim 5, wherein the mechanical rotor (221) of the electromagnetic clutch is supported by said auxiliary spindle (202) and rotationally integral therewith.

8. The operating assembly according to claim 6, wherein said auxiliary spindle is coaxial with the driven shaft (2) supporting the impeller.

9. The operating assembly according to claim 1, comprising a rotor flange (233) rotationally integral with a rear end (2b) of the shaft (2) opposite to the end supporting the impeller (1).

10. The operating assembly according to claim 1, wherein said electric drive comprises: a radially inner stator (31) supported by the support body (11), and a radially outer rotor (32) mounted on a rotor flange (233) rotationally integral with the shaft (2) and configured to arrange the rotor in a radially outer position concentric with the stator for radial coupling therewith.

11. The operating assembly according to claim 5, wherein the armature (225) of the electromagnetic clutch is rotationally coupled with a rotor flange (233) with the possibility of being displaced axially by means of an elastic plate (226), so as to couple or decouple a rear end surface of the armature and said front surface of the mechanical rotor (221).

12. The operating assembly according to claim 4, wherein a rotor flange (233) is axially arranged between the front electric drive and the armature (225) of the electromagnetic clutch.

13. The operating assembly according to claim 2, wherein the bell member (113) of the support body extends in the axial direction over a length such as to contain inside it both the electromagnetic clutch (220) and the electric drive (30).

14. The operating assembly according to claim 1, wherein the movement take-up element comprises a movement take-up flange (223), fixed to the rear end of the auxiliary spindle (202), the flange (223) having a radially outer axial arm, with an outer side surface which forms a movement take-up pulley (223a), and a radial arm (223b) connected to the spindle (202).

15. The operating assembly according to claim 14, wherein the movement take-up flange defines an internal volume (223c) between the outer axial arm and the auxiliary spindle, inside which a rear foot (113c) of the support body (10) is at least partially housed.

16. The operating assembly according to claim 1, characterized by further comprising an arrangement which comprises, in sequence in the axial direction along the axis of rotation of the driven shaft (2): the front end supporting the impeller (1), an electric motor (30), a rotor flange (233) which carries the electric rotor, an armature (225) of the electromagnetic clutch, a mechanical rotor (221) of the electromagnetic clutch, an electromagnet (222) and said movement take-up element (223).

17. The operating assembly according to claim 16, wherein the electric rotor (33) and the armature (225) are rotationally coupled to the impeller shaft (2), and the mechanical rotor (221) and the movement take-up element (223) are rotationally coupled to an auxiliary spindle (202), separate from the shaft (2) supporting the impeller.
